(19) United States
(12) Patent Application Publication
(10) Pub. No.: US 2024/0384135 A1
(43) Pub. Date: Nov. 21, 2024

(54) SOFT TOY REPAIR DEVICE AND SYSTEM

(71) Applicant: Brad Gruber, Hauppauge, NY (US)

(72) Inventor: Brad Gruber, Hauppauge, NY (US)

(21) Appl. No.: 18/320,765

(22) Filed: May 19, 2023

(51) Int. Cl. C09J 7/24; A01K 15/02; C09J 7/40

(52) U.S. Cl. CPC C09J 7/243; A01K 15/025; C09J 7/401; C09J 2203/358; C09J 2400/28; C09J 2423/101

(57) ABSTRACT

A soft toy repair device is provided as a non-toxic and pet safe recyclable patch operative to secure tears in an outermost surface layer of soft or plush toys, and pet toys in particular, via adhesion. Such patch comprises an at least partially translucent, flexible tape having backing layer and an adhesive layer, the backing layer having a top side and a bottom side, the adhesive layer applied to the bottom side of the backing layer. A soft toy repair system further comprises a release liner operative to preserve the adhesive layer, which may be a pet-safe, non-toxic and pressure sensitive rubber adhesive, until use. As configured, the patch is operative to remain in place even when subjected to pet play and rough handling.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to repairing soft material and, more particularly, to a recyclable and rugged adhesive patch for repairing tears in soft or plush pet toys subject to forceful play.

### BACKGROUND

Soft plush toys are a popular item among children, adults, and pets alike. It is well known, however, that, over time, these toys can become worn and damaged, particularly when they are well-loved and played with often. This is especially true of plush pet toys, which are generally subject to play by tugging and by teeth. As such, one common issue with plush toys, and plush pet toys more specifically, is that their outer most woven or knit fabric layer(s) may become torn or ripped, which can result in stuffing coming out and such toys losing their shape. Toys that children and pets develop an emotional attachment to are often the ones that are most prone to damage and may cause emotional distress when torn or no longer functional. As a result, pet owners and parents are inclined to fix these toys whenever feasible.

Various methods and devices have been developed for repairing plush toys. For instance, it is possible to stitch or darn rips and tears closed. However, this requires specialized crafting supplies, know-how, and fine motor skills that have fallen out of common usage in the modern day and age. Indeed, this method is also time consuming and may not provide a durable or aesthetically satisfactory result depending on the skill level of the repairer.

Some have proposed patching tears and rips with certain adhesives. Some examples of such proposals follow. U.S. Pat. No. 4,715,914 to Viner discloses a specialized hand-held implement for use in repairing tears in fabric apparel items to be used with a pre-form patch bearing a heat activated adhesive and a heated ironing device. U.S. Pat. No. 3,985,598 to Trenda et al. teaches a material repair process that includes buffing a smooth surface comprising synthetic fibers to be repaired to artificially raise a nap on the threads, then applying, with pressure and heat, a patch to the buffed area. However, these proposals are deficient. Using heat on plush toys made of materials like faux fur and polyester may not be a good idea, as these materials are prone to melting. Melting plastic can be harmful if ingested by a dog and can also alter the texture and appearance of the material in an unappealing way.

Some have proposed other adhesives that may be applied without heat. U.S. Pat. No. 3,772,114 to Kowalchuk describes an adhesive containing a color additive to provide a color match between the adhesive and fabric to be mended so that the adhesive visually blends with the fabric that it is applied to. U.S. Pat. Pub. No. 2015/0306843 filed by White et al. teaches a stick-on patch made from a fabric-like polymer substrate, such as woven polyester, on which a design or information has been printed and may be applied as a decoration or repair device for fabric such as clothing and outdoor equipment including tents and awning. U.S. Pat. Pub. No. 2009/0223622 filed by Llano teaches a self-adhering fabric patch for outdoor gear that is digitally printed with a pattern to match the pattern of the clothing, equipment, or cover that it is intended to repair and avoids a need to manually stich or otherwise rely on hot melt adhesives that may be difficult to activate in the field when needed. In proposals like these, patches are typically decorated or colored to match the visual appearance of a specific surface. However, with plush pet toys being available in countless colors, it is impractical to ensure a close visual match for every possible toy.

Thus, although various proposals have been made to solve the problem of repairing soft pet toys, none of those in existence combine the characteristics of the present invention. Therefore, there remains a need for a repair device that can be applied to the soft, outer layer of a plush toy quickly and with little skill that will visually blend with a variety of materials and will also stand up to rough play by pets.

### SUMMARY

The present disclosure is directed to a soft toy repair device configured as a recyclable patch for securing tears and other damage in soft toys, particularly plush pet toys that may be subjected to damaging rough play.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the patch comprises an at least partially translucent, flexible tape having a backing layer and an adhesive layer. The backing layer and the adhesive layer may comprise any pet-safe, rugged material known for such purpose, however, certain materials are contemplated for their particular transparent, flexible, and durable qualities. In some embodiments, the backing layer, having a top side and a bottom side, may comprise any of a thin, at least partially transparent thermoplastic polymer polypropylene tape, polyester film, or polyvinyl chloride (PVC) tape so that when outwardly applied to a torn potion of a plush pet toy, an outer surface of such toy remains visible through the patch. Indeed, such films or tapes may also be colorless so as to avoid significantly visually interfering with the color, pattern, or design of the plush pet toy.

In some embodiments, the backing layer comprises biaxially-oriented polypropylene (BOPP) in particular. The usual method of producing BOPP, which will be known to those of ordinary skill in the art, results in a film that can be clear or translucent, as well as tear, moisture, and solvent-resistant; flexible; non-toxic; and even recyclable.

The adhesive layer, applied to the bottom side of the backing layer, may be any pet-safe, non-toxic, pressure sensitive adhesive operative to bond with any of the countless materials that comprise soft plush toys. In some embodiments, the adhesive layer is a pressure sensitive natural or synthetic rubber adhesive having high stripping and high cohesion strength. The high cohesion strength means that the adhesive is configured to hold adhered surfaces together even under stress or strain, while the high stripping means that it resists being pulled away from the surface it is bonded to. It will be recognized that these properties are particularly desirable in applications for pet toys and other plush or soft toys that may be subject to rough play. In some embodiments, the adhesive will also be suitable for general hook double sides, which refers to a type of adhesive tape or fastener that provides a strong and durable bond between two surfaces while also permitting easy and clean removal when needed or desired.

In some embodiments a soft toy repair system comprises the patch in addition to a release liner operative to preserve the adhesive layer until use. That is the release liner, when positioned in contact with the adhesive layer will prevent the adhesive from curing or “drying out” prior to application of the patch to the outer surface of the plush toy. Glassine is particularly contemplated to comprise the release liner in light of its air, water, and grease resistance. In addition, as a pulp, rather than polymer-based material, glassine is generally curbside recyclable and may be considered a more environmentally friendly option than alternative release liners that comprise, for instance, silicone, PET, and polypropylene. Indeed, as glassine is not waxed or chemically-finished during manufacture, glassine release liners may even be compostable and generally regarded as biodegradable.

To even further prevent damage to the patch and preserve the adhesive until use, the soft toy repair system may further comprise a packet or pouch configured to fully envelope the patch as applied to the release liner until needed or desired. For instance, the system may comprise a paper pouch defining a space to contain the patch and release liner and configured to be torn open. In some embodiments, one or more notches may be disposed in an outer edge portion of the pouch to enable a user to more easily tear the pouch open to retrieve its contents.

As such, the patch is operative to repair tears in fabric knit or woven toys, such that the adhesive layer adheres securely to the outermost surface layer of the soft toy and remains in place even when subjected to pet play and rough handling. It is contemplated that providing a flexible and translucent patch according to the disclosure and claims provided below may provide an expedient means for repairing beloved toys and reducing waste associated with replacing otherwise repairable toys.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective, exploded view of a soft toy repair system in accordance with one embodiment of the invention.

FIG. 2 shows a perspective, exploded view of one aspect of a soft toy repair device in accordance with one embodiment of the invention.

FIGS. 3 and 4 show application of one embodiment of a soft toy repair device in accordance with one embodiment of the invention.

FIGS. 5 and 6 show exemplary alternative embodiments of a soft toy repair device.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

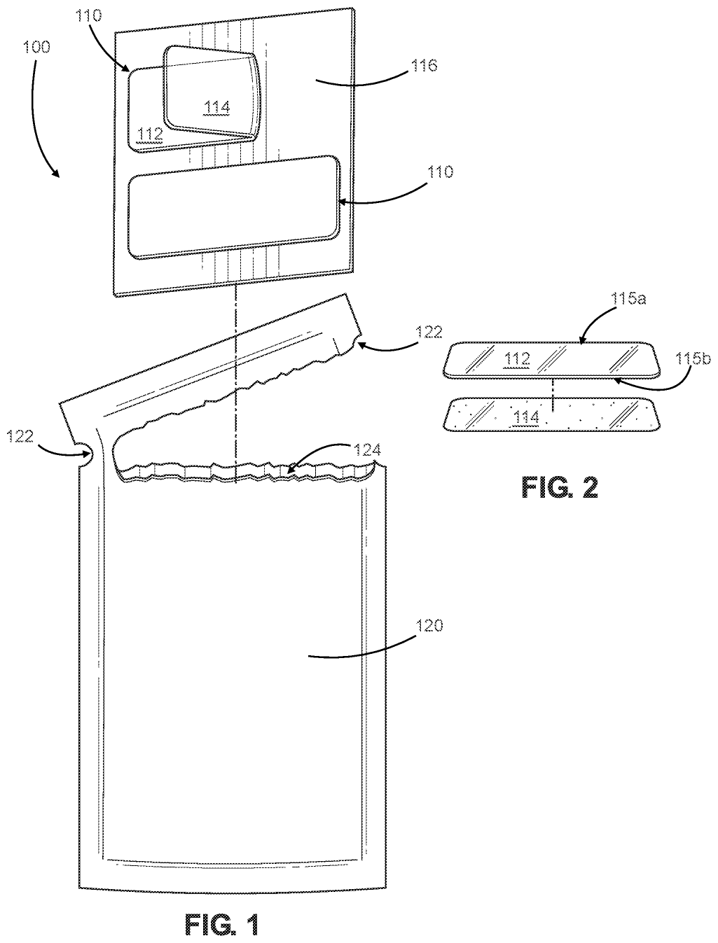

With reference to FIG. 1 a soft toy repair system 100 may comprise at least one patch 110 as an at least partially translucent, flexible tape having a backing layer 112 and an adhesive layer 114, and a release liner 116 operative to preserve the adhesive layer until use. As shown in FIG. 1, the release liner 116 may be sized to accommodate a plurality of patches 110. To even further prevent damage to the patch 110 and preserve the adhesive layer 114 until use, the soft toy repair system 100 may further comprise a packet or pouch 120 configured to fully envelope the patch 110 as applied to the release liner 116 until needed or desired. For instance, the system may comprise a paper pouch 120 defining a space 124 to contain the patch 110 and release liner 116 and configured to be torn open. In some embodiments, one or more notches 122 may be disposed in an outer edge portion of the pouch 120 to enable a user to more easily tear the pouch 120 open to retrieve its contents.

The backing layer 112 and the adhesive layer 114 may comprise any pet-safe, rugged material known for such purpose, however, certain materials are contemplated for their particular transparent, flexible, and durable qualities. In some embodiments, and with reference to FIG. 2, the backing layer 114, having a top side 115a and a bottom side 115b, may comprise any of a thin, at least partially transparent thermoplastic polymer polypropylene tape, polyester (PET) film, or polyvinyl chloride (PVC) tape so that when outwardly applied to a torn potion of a plush pet toy, an outer surface of such toy remains visible through the patch. Indeed, such films or tapes may also be colorless so as to avoid significantly visually interfering with the color, pattern, or design of the plush pet toy.

In some embodiments, the backing layer 114 comprises biaxially-oriented polypropylene (BOPP) in particular. The usual method of producing BOPP, which will be known to those of ordinary skill in the art, results in a film that can be clear or translucent, as well as tear, moisture, and solvent-resistant; flexible; non-toxic; and even recyclable.

The adhesive layer 114, applied to the bottom side 115b of the backing layer 112, may be any pet-safe, non-toxic, pressure sensitive adhesive operative to bond with any of the countless materials that comprise soft plush toys. Pressure sensitive adhesive, also known as peel and stick adhesives form as a bond when applied to bond the adhesive with a surface. It is contemplated that this may be achieved without reliance on any solvents, water, or heat that may otherwise be needed to activate the adhesive 114. Indeed, it is contemplated that the adhesive layer 114 of the soft toy repair device is operative to form a bond, at room temperature, with knit or woven, fleece, flannel, felt, flocked, furry, minky, and/or any other natural or synthetic fabric or fiber material and combinations of the same known to constitute the often soft or plush outer layer of a typical stuffed pet toy.

In some embodiments, the adhesive layer 114 is a pressure sensitive natural or synthetic rubber adhesive having high stripping and high cohesion strength. In other words, the adhesive layer 114 is configured and operative to hold adhered surfaces together even under stress or strain while it additionally resists being pulled away from the surface it is bonded to. In addition, the adhesive will also be suitable for general hook double sides, meaning that it may be configured to provide a strong and durable bond between two surfaces while also permitting easy and clean removal when needed or desired. It will be recognized that these properties are particularly desirable in applications for pet toys and other plush or soft toys that may be subject to excessive and even rough play.

As with the backing layer 112, it is contemplated that the adhesive layer 114 may be colorless, so as to avoid visually interfering with the color, pattern, or design of the plush pet toy that it is applied to. However, in some embodiments, is it contemplated that the adhesive layer 114 may have a slight yellow tint as a result of UV stabilizers and other additives known to improve their performance. However, it is contemplated that any coloring will be minor and even negligible, and, in any event, will not interfere with the translucency of the backing layer 112. In one embodiment, the adhesive comprising the adhesive layer 114 is viscous and has a solid content of about 55% to about 65%. In some embodiments, the solid content, a property known to those of ordinary skill in the art, is about 60%±about 1%.

In some embodiments, the backing layer 112 may be about 50 thousandths of an inch (mils) or about 1270 microns thick. In some embodiments, the adhesive layer 114 may be much thinner than the backing layer at about 40 microns thick. Of course, these figures are provided for example only and not limitation. One of ordinary skill in the art will recognize that the particular thickness of the backing layer 112 and adhesive layer 114 of the patch may be selected or optimized for application to different plush or stuffed toy materials without departing from the invention. For instance, certain materials may be more effectively repaired by application of a relatively thick backing layer 112 and adhesive layer 114.

It is contemplated that the release liner 114, when placed in contact with the adhesive layer 114 will prevent the adhesive from curing or “drying out” prior to application of the patch 110 to the outer surface of the plush toy. Glassine is particularly contemplated to comprise the release liner 114 in light of its air, water, and grease resistance. In addition, as a pulp, rather than polymer-based material, glassine is generally curbside recyclable and may be considered a more environmentally friendly option than alternative release liners that comprise, for instance, silicone, PET, and polypropylene. Indeed, as glassine is not waxed or chemically-finished during manufacture, glassine release liners may even be compostable and generally regarded as biodegradable.

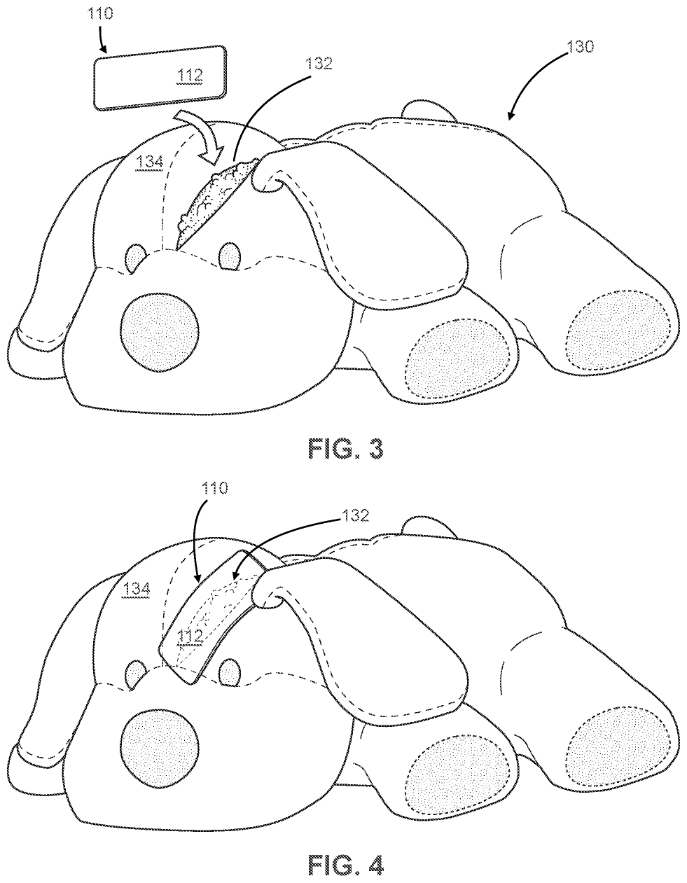

FIGS. 3 and 4 are provided to show the patch 110 in use. This is, of course, just one example provided for the sake of clarity, and will not limit the invention. More particularly, a stuffed toy 130 is shown with a tear 132 exposing internal fill or stuffing 134, which, if unaddressed, will likely fall out of the stuffed toy 130. The patch 110 may be applied, by hand or with the use of some implement such as tweezers, craft sticks, and the like, to an outer surface 134 of the stuffed toy at the tear 132, with the backing layer 112 facing outward. As seen in FIG. 4, the transparency of the patch 110 allows the outer surface 134 of the stuffed toy 130 to remain visible. In this case, it may also be seen that the tear was unaltered before application of the patch 110 to the outer surface 134 to the stuffed toy 130, however, it is contemplated that the tear or other damage may be pinched or sewn closed in advance to achieve a more secure or even visually cohesive finish. In other words, the patch 110 may be deployed to supplement or reinforce other methods for repairing damage to soft toys.

In some embodiments, and depending on the composition of the adhesive layer 114, it may be beneficial to avoid manipulating or playing with the toy for some period of time in order to allow the adhesive layer 114 to cure. Failing to do so may cause the patch to fail and the tear to reopen. In some embodiments, the adhesive layer may be operative to cure within one hour of application to the toy surface. In some embodiments, the adhesive layer may be operative to cure within half an hour, within 10 minutes, within 5 minutes, within 2 minutes, or even within 1 minute. Of course, a faster curing time may be associated with higher satisfaction on the part of the owner of the stuffed toy who may wish to be reunited with the repaired toy as soon as possible.

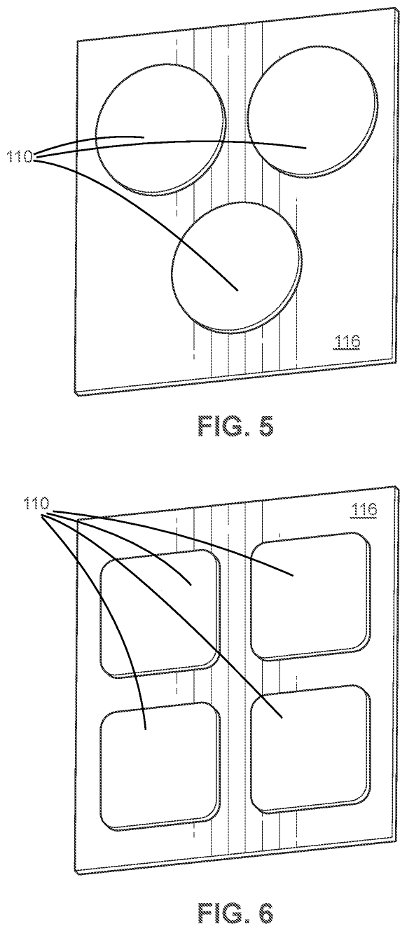

In some embodiments, the patch 110 selected to repair the stuffed toy 130 may be sized larger than the tear 132 itself, as shown in the figures. However, it is contemplated that a plurality of patches may be used to repair any tears if necessary or desired. Indeed, it may be seen with reference to FIGS. 5 and 6 that a plurality of patches 110 may be provided on a release liner 116 in any number or shape contemplated. The exemplary patches 110 appear as circles and squares in the figures, however, one of ordinary skill in the art will recognize that any shape or size is possible without departing from the invention. Certain shapes may be preferred for their ability to match contours in the stuffed toy and visually blend better with the outer surface of such toy. In some exemplary embodiments, one or more rectangular patches may be about 2 to about 4 inches tall by about 4 to about 6 inches wide. One or more circular patches may be about 2 to about 4 inches in diameter. On or more square patches may be about 2 to about 4 inches square. Thus, it will be understood that the particular dimensions and shape of the patch will not limit the invention.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### Conclusions, Ramifications, and Scope

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the soft toy repair device and system with which that terminology is associated. In general, the terms used in the following claims should not be constructed to limit the soft toy repair device and system to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the soft toy repair device and system is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the soft toy repair device and system.

What is claimed is:

1. A recyclable patch for repairing damage in an outermost surface layer of a soft toy, comprising:
an at least partially translucent, flexible tape having a biaxially-oriented polypropylene (BOPP) backing layer and an adhesive layer, the backing layer having a top side and a bottom side, the adhesive layer applied to the bottom side of the BOPP backing layer; and
a removable release liner operative to preserve the adhesive layer until use;
wherein the adhesive tape is operative to repair tears in fabric knit or woven toys, such that the adhesive layer adheres securely to the outermost surface layer of the soft toy and remains in place even when subjected to pet play and rough handling, and
wherein the recyclable patch is safe for use by pets and non-toxic.

2. The recyclable patch of claim 1, wherein the backing layer is up to about 50 mils thick.

3. The recyclable patch of claim 1, wherein the adhesive layer is up to about 40 microns.

4. The recyclable patch of claim 1, wherein the release liner comprises glassine.

5. The recyclable patch of claim 1, wherein the backing layer has an area of about 4 to about 8 square inches.

6. A system for repairing tears in a pet's stuffed toys, comprising:
at least one patch having a flexible backing layer and an adhesive layer on one side of the backing layer, the adhesive layer being composed of a non-toxic, pet-safe adhesive material that is capable of adhering to the surface of the pet's stuffed toy and maintaining its adhesive properties even when exposed to pet play and rough handling;
a release liner covering the adhesive layer, the release liner being easily removable by a pet owner prior to use; and
a protective pouch defining an opening and configured to maintain the at least one patch and release liner until use.

7. The system of claim 6, wherein the flexible backing layer comprises translucent biaxially-oriented polypropylene (BOPP).

8. The system of claim 6, wherein the release liner comprises glassine.

9. The system of claim 6, wherein the backing layer is up to about 50 mils thick.

10. The system of claim 6, wherein the adhesive layer is up to about 40 microns.

11. The system of claim 6, wherein the pouch comprises kraft paper.

12. The system of claim 6, further comprising at least one rectangular patch, at least one circular patch, and at least one square patch.
